(19) United States
(12) Patent Application Publication
(10) Pub. No.: US 2024/0195797 A1
(43) Pub. Date: Jun. 13, 2024

(54) Systems and Methods to Ensure Proximity of a Multi-Factor Authentication Device

(71) Applicant: Cisco Technology, Inc., San Jose, CA (US)

(72) Inventors: Shayne Miel, Durham, NC (US); Richard Harang, Alexandria, VA (US)

(21) Appl. No.: 18/063,151

(22) Filed: Dec. 8, 2022

(51) Int. Cl. H04L 9/40

(52) U.S. Cl. CPC H04L 63/083; H04L 63/107; H04L 63/20; H04L 2463/082

(57) ABSTRACT

The present technology provides for a proximity authentication technique in response to a detection of a possible attack, degradation in trust level, or as required by a policy associated with a first resource. Methods and systems include receiving an authentication request to authenticate a user account to a first service, where the authentication request is from an access device. A passcode is sent to the access device, where the d passcode is associated with the authentication request. Co-location of the authentication device and the access device is determined by receiving a communication from an authentication device including the passcode associated with the user account, where the authentication device extracted the passcode from a message broadcast over Bluetooth Low Energy from the access device.

### TECHNICAL FIELD

The present disclosure relates to multi-factor authentication. Aspects of the disclosure involve authenticating a user account based on the physical proximity of a multi-factor authentication device to an access device.

### BACKGROUND

Two-factor authentication (2FA) is a simple, effective way to make sure users are whom they say they are. Two-factor authentication is important to network security because it mitigates the risks associated with compromised passwords. If a password is hacked, guessed, or phished, it is no longer enough to give an intruder access because without approval at the second factor, a password alone may not be useful. However, 2FA is not impervious to nefarious attempts that try to circumvent the second factor authentication methods.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example multi-factor authentication (MFA) system in accordance with some aspects of the present technology;

FIG. 2 illustrates an example method in accordance with some aspects of the present technology;

FIG. 3 illustrates an example method including setting a time period in accordance with some aspects of the present technology;

FIG. 4 illustrates an example method of authenticating a user over a period of time in accordance with some aspects of the present technology;

FIG. 5 illustrates an example method for disabling access to a user account in accordance with some aspects of the present technology;

FIG. 6 shows an example of computing system 600, which can be, for example, any computing device that can implement components of the system described herein.

### DETAILED DESCRIPTION

Certain aspects of this disclosure are provided below. Some of these aspects can be applied independently and some of them can be applied in combination as would be apparent to those of skill in the art. In the following description, for the purposes of explanation, specific details are set forth in order to provide a thorough understanding of aspects of the application. However, it will be apparent that various aspects can be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes can be made in the function and arrangement of elements without departing from the spirit and scope of the application as set forth in the appended claims.

### Overview

In one aspect, a method for using multi-factor authentication to authenticate a user account includes receiving an authentication request to authenticate a user account to a first service, where the authentication request is from an access device. A passcode is sent to the access device, where the passcode is associated with the authentication request. Co-location of the authentication device and the access device is determined by receiving a communication from an authentication device including the passcode associated with the user account, where the authentication device extracted the passcode from a message broadcast over Bluetooth Low Energy from the access device.

In another aspect, the user account is authenticated with the first service based on a unique ID and the passcode having been received from the authentication device. A successful authentication message is sent to the first service, where the successful authentication message causes the first service to establish a session between the access device and the resource.

In another aspect, sending the unique ID and passcode to the access device and receiving the unique ID and passcode from the authentication device requires no interaction from a user.

In another aspect, a time period associated with the unique ID and passcode is set, where after the time period expires, the unique ID and passcode are no longer valid to authenticate the user account with the first service.

In another aspect, the authentication device is not required to be paired with the access device when the authentication device extracts the unique ID and passcode from the broadcasted message.

In another aspect, the communication further includes contextual information associated with at least one of the user account, the access device, and the authentication device.

In another aspect, the first service is associated with an access policy configured at an authentication service, the access policy specifying a rule for determining when the unique ID and passcode are sent to the access device.

In one aspect, a computing apparatus includes a processor and a memory storing instructions that, when executed by the processor, cause the apparatus to receive an authentication request to authenticate a user account to a first service, where the authentication request is from an access device. A passcode is sent to the access device, where the passcode is associated with the authentication request. Co-location of the authentication device and the access device is determined by receiving a communication from an authentication device including the passcode associated with the user account, where the authentication device extracted the passcode from a message broadcast over Bluetooth Low Energy from the access device.

In another aspect, the user account is authenticated with the first service based on a unique ID and the passcode having been received from the authentication device. A successful authentication message is sent to the first service, where the successful authentication message causes the first service to establish a session between the access device and the resource.

In another aspect, sending the unique ID and passcode to the access device and receiving the unique ID and passcode from the authentication device requires no interaction from a user.

In another aspect, a time period associated with the unique ID and passcode is set, where after the time period expires, the unique ID and passcode are no longer valid to authenticate the user account with the first service.

In another aspect, the authentication device is not required to be paired with the access device when the authentication device extracts the unique ID and passcode from the broadcasted message.

In another aspect, the communication further includes contextual information associated with at least one of the user account, the access device, and the authentication device.

In another aspect, the first service is associated with an access policy configured at an authentication service, the access policy specifying a rule for determining when the unique ID and passcode are sent to the access device.

In one aspect, a non-transitory computer-readable storage medium includes instructions that when executed by a computer, cause the computer to receive an authentication request to authenticate a user account to a first service, where the authentication request is from an access device. A passcode is sent to the access device, where the passcode is associated with the authentication request. Co-location of the authentication device and the access device is determined by receiving a communication from an authentication device including the passcode associated with the user account, where the authentication device extracted the passcode from a message broadcast over Bluetooth Low Energy from the access device.

In another aspect, the user account is authenticated with the first service based on a unique ID and the passcode having been received from the authentication device. A successful authentication message is sent to the first service, where the successful authentication message causes the first service to establish a session between the access device and the resource.

In another aspect, sending the unique ID and passcode to the access device and receiving the unique ID and passcode from the authentication device requires no interaction from a user.

In another aspect, a time period associated with the unique ID and passcode is set, where after the time period expires, the unique ID and passcode are no longer valid to authenticate the user account with the first service.

In another aspect, the authentication device is not required to be paired with the access device when the authentication device extracts the unique ID and passcode from the broadcasted message.

In another aspect, the communication further includes contextual information associated with at least one of the user account, the access device, and the authentication device.

### Detailed Description of Example Embodiments

Disclosed herein are systems and methods for ensuring proximity of a multi-factor authentication device to an access device as one factor in a multi-factor authentication (MFA) to mitigate or remove the risk associated with varying types of attacks. The systems and methods disclosed herein use signals (e.g., Bluetooth Low Energy (BTLE)) from an access device (e.g., a laptop) sent to an authentication device (e.g., a mobile device) to determine, in real-time or close to real-time, whether the authentication device is within a proximity of the access device when access to a resource (e.g., a work application) is requested. If so, the system can determine that the user account, and presumably the user, is authentic and can access the resource through the access device. In this regard, when an access device requests access to a resource and the user attempts to authenticate with an authentication service (e.g., DUO) to interact with the resource, the authentications service can use the verified proximity of the authentication device as one factor in the multi-factor authentication.

In multi-factor authentication, when a user performs second factor authentication through a service, such as DUO or OKTA, they are often presented with a number of possible factors that they can use to authenticate their identity. One such factor can include a push to a mobile application where the user can decide to authenticate by selecting an “approve” type of input (e.g., a GUI button) provided by the mobile application. For example, a push to a mobile application, such as a push to Duo Mobile, typically includes the following steps: (1) a server receives a pre-authorization request (e.g., a user entered a password correctly, and now the server is being requested to send a MFA push); (2) the server cross-checks information to make a determination on whether the characteristics associated with the user comply with a policy (e.g., a company user policy) which allows the user to access the requested service. Such cross-checked information can include information associated with the user's IP address, whether or not the user is on a permitted network (e.g., their home private network), browser information (e.g., browser version, what extensions are installed, etc.), the operating system (OS) type, type of computer, a unique ID of an application being accessed, the company, time of day, etc. Based on these types of information, the server decides whether the user is compliant with the policy, and then; (3) the server provides the MFA push to the user, for example by sending, to a known device registered with the user, a request for the user to acknowledge the sign-in request. This acknowledgment can be in the form of two confirmation buttons, one approving the request and one disapproving the request. It should be noted that the type of MFA provided to the user can be user selectable or can be based on the policy associated with the company, service, user, other methods, or any combination thereof. If the user selects the “approve” button, the device originally seeking the connection permission is allowed to connect to the respective service. In this regard, the user seeking authentication is also the user having both the access device and the authentication device, but bad actors can try to falsify the push to verify from the access device and are in most cases not within a close (e.g., 50 feet) proximity of the access device.

Bad actors targeting specific services can obtain large amounts of data from a data breach, including user information such as usernames and passwords. These data breaches, which are becoming increasingly prevalent, help facilitate attacks. However, usernames and passwords account for only one factor in multi-factor authentication. The bad actors utilize other sources to try to gain access to the resources. Some of the MFA factors are more susceptible to certain attacks than others. For example, a push style authentication factor can be compromised by a “push fraud” style of attack, among others. A push fraud attack occurs when a bad actor uses or falsifies an unauthorized authentication from the authentication device. In some examples, the bad actor has stolen or received a stolen access device or authentication device. In this regard, the authentication device is not located near the access device which can signify that the user requesting access is not the user with privileges to access the resource.

Another example of an attack that can exploit certain MFA factors is “Passcode Phishing” (also known as adversary-in-the-middle). Passcode phishing can occur when a bad actor sets up a fake site (e.g., a web portal mimicking the look of a real service portal site) that looks like a legitimate passcode prompt to collect passcodes from users and reuse them to gain fraudulent access. The attacker sends a user through a proxy and retrieves credentials and/or session tokens by manipulating the end user into thinking they are authenticating into a legitimate resource or application. Attackers often pose as people or organizations a user could have interacted with or that sound official, such as businesses, government organizations, and trusted service providers. These attacks are not necessarily new, but hacking tools/scripts are constantly evolving and have made it easier for attackers to execute them. Although identified methods of passcode phishing are discussed above, it should be noted that bad actors can use other methods, such as malware, virus software, ransom software, social engineering (e.g., fraudulent emails requesting information from the user or requesting password resets), combinations of the same, etc., to obtain user information in a phishing attack.

An adversary-in-the-middle or a passcode phishing attack can be identified as occurring by the system based on the IP address associated with the request or can be identified based on software (e.g., an endpoint agent on the end-user's computing device) that identifies the IP of the end-user. For example, a bad actor can setup a portal, such as a web portal, that mimics a genuine portal an end-user can utilize to sign into a service (e.g., “du0.com” with a zero instead of “duo.com” with an “o”). A user may not notice the slight difference in web addresses after accidently typing “du0.com” which can easily occur due to the proximity of the zero key on the keyboard as compared to the “o” key. In this example, the adversary-in-the-middle can intercept the user's login password and username, communicate the information to the actual server, and relay the response to the end-user without the end-user noticing that the portal is not authentic. The bad actor can then use the phished information to request a multi-factor authentication and login as the end-user after the end-user approves the request for authentication based on their own attempt (albeit at an erroneous portal) to login. In this regard, the adversary-in-the-middle intercepts the end-user's information and uses the information along with the fact that the user is simultaneously trying to log in to trick the user into approving a request for authentication, thereby gaining unauthorized access to the service. In another example, the software (e.g., the endpoint agent) can identify and notify the system that the request for authorization is coming from a suspicious source by comparing the IP address associated with the end-user to the IP address of the request's source and determining they are not the same. In another example, the software can use other information (e.g., browser information, operating system information, location, packet timing, etc.) to identify that the end-user did not make the request for authentication. In this regard, the identification of an adversary-in-the-middle or passcode phishing attack is occurring can be based on packet timing information. For example, the request for authentication can take a certain number of hops or a certain amount of time to reach the system whereas a pre-authorization can take a different amount of time to reach the system, and based on a threshold, the system can determine that the packet timing for each is too different which can signal an attack.

Once the system has identified that a certain type of attack is occurring, a trust level has been lowered or downgraded below a threshold, or if a policy asserts that the user account must be authenticated using the proximity technique discussed herein, the system can initiate the proximity method as one factor in the multi-factor authentication process. In another example, if the system identifies a passcode phishing or adversary-in-the-middle attack, the system can temporarily block the passcode as an available authentication factor and require the proximity method, among other MFA factors. The system can also determine, based on policy, trust levels, an identification of an ongoing attack, combinations thereof, etc., that a threshold update is required. In this regard the system can adjust the thresholds or can prompt a company/service administrator to update the thresholds based on any number of metrics including frequency of attacks, number of falsely identified attacks, time periods, etc. It should be noted that the system can use artificial intelligence (AI) software to track and determine thresholds in various possible examples.

In some examples, the system can identify when to use the proximity method based on a rule or policy associated with the type of attack, company, and/or the type of service. In other examples, a company/service administrator can decide when to use the proximity method for the end-user to continue authentication. In this regard, when to use the proximity method can be configurable and can be specific to each company/service. In one example, when to use the proximity method can be end-user specific or can pertain to certain groups of end-users.

The proximity authentication technique of the present disclosure can increase the trust level associated with a user account and/or authenticate a user account by confirming that the access device and the authorization device are in close proximity to each other, thereby increasing a likelihood that the user is authentic. The systems and methods described herein can utilize communication modules present in the access device to verify the proximity of the access device. For example, a user can attempt to sign into a resource (e.g., by opening the resource application or navigating to a resource web portal) using a primary authentication technique, such as a username and password, passcode, one-time passcode (OTP), biometric, WebAuthn, other authentication device, combinations of the same, etc.

After the user supplies the primary authentication method, a secondary or multi-factor authentication method can be required, such as by a policy associated with the resource, authentication service, or both. The resource will send an authentication request (e.g., sent from the resource server or from the resource application) to the authentication service. The authentication service, after having received the request associated with the user account and resource, can initiate an MFA with the user account by sending (e.g., through a Transmission Control Protocol (TCP) tunnel) a unique ID and a unique passcode associated with the request to the access device. The unique ID and passcode can be received by the authentication application running on the access device (e.g., DUO Health App) where the authentication application is programmed to utilize a communication module of the access device (e.g., BTLE) to broadcast the unique ID and the passcode.

At the same time or close to the same time, the authentication service can send (e.g., through a cellular network) a communication to an authentication device associated with the user account and the resource. For example, the authentication service can send a single message containing the unique ID and passcode to the access device (via TCP), and a single message containing only the unique ID (e.g., without the passcode) to the authentication device (via the cell network). The unique ID lets the authentication device know which Bluetooth Low Energy (BLE) message, out of the many BLE messages the authentication device might be able to see, is the appropriate one to parse a passcode from and send back to the authentication service.

The access device can begin broadcasting the BLE message containing the unique ID and passcode. At the same time, the authentication device could poll for any BLE message(s) in its proximity that contains that unique ID. If the authentication device finds a BLE message containing the unique ID within a fixed period of time, the authentication device parses the passcode out of that BLE message and sends both the unique ID and passcode to the authentication service via a TCP connection. Thus, the authentication service can verify that the access device and the authentication device are within at least a broadcast range proximity of each other or otherwise co-located.

In some embodiments, in some cases, the authentication service can send only a passcode to the access device and sends no additional information to the authentication device. Then the authentication device would need to collect every BLE message it can see and send them all back up to the authentication service, where the authentication service would have to search through the collected BLE messages to see if any of them contained the passcode it sent to the access device.

The authentication service can decide based on the verified proximity that the user is authorized to access the resource and/or can increase a trust level associated with the user account. This verified proximity is especially helpful for verifying identity when a user is signing on to a virtual private network (VPN). As one skilled in the art would recognize when using a VPN, the user can appear (e.g., based on their IP address) to be in one physical location and then another physical location (e.g., East Coast to West Coast) in a matter of seconds after signing on to the VPN. This can be problematic because an adversary-in-the-middle attack can present similar characteristics where the authorized user is in one location but the request for authentication comes from a spoofed or false web portal in another location. By using the proximity method describe herein, an authentication service can mitigate the risks associated with the adversary-in-the-middle attacks, among others.

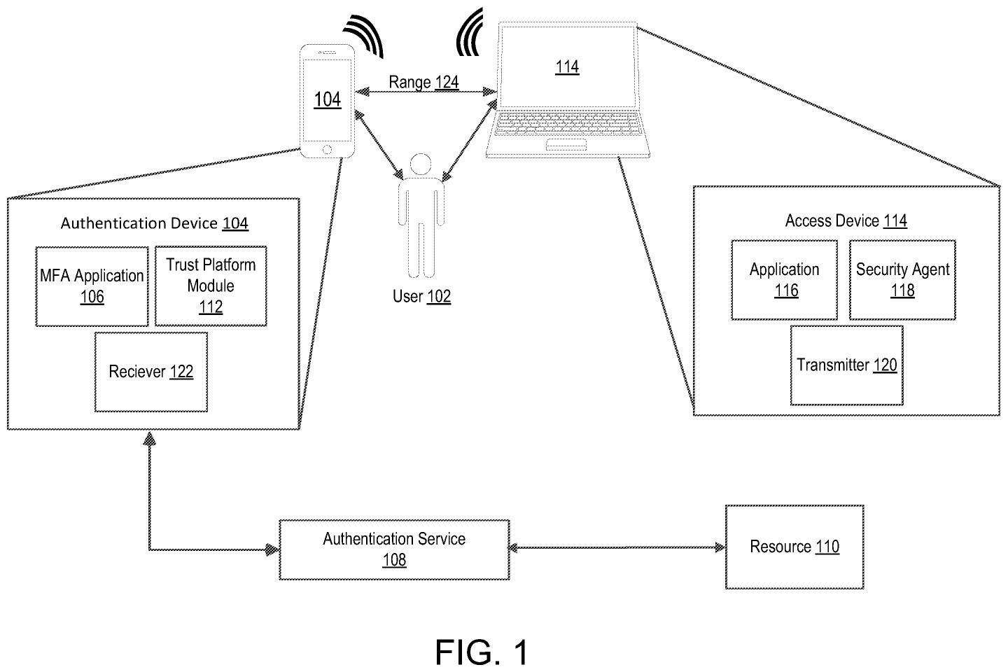

FIG. 1 illustrates an example environment utilizing a multi-factor authentication (MFA) system in accordance with some aspects of the present technology. User 102 can gain authorized access to resource 110 by using authentication device 104. User 102 can be any user including a customer, employee, contractor, client, member of an organization, or private individual, etc. attempting to access a service. The authentication device 104 can be hardware, software-only, or combinations thereof. The authentication device 104 can be a mobile device or a personal computer.

Resource 110 can be any service, resource, device, or entity which requires authentication of user 102. For example, resource 110 can be a social media service, bank, hospital, motor vehicle department, bar, voting system, Internet of Things (IOT) device, or access device. In some embodiments, resource 110 can be accessed by user 102 through an authentication device 104, such as a mobile phone or personal computer. In some embodiments, resource 110 can be accessed by user 102 through an application 116 on an access device 114 that is specifically designed for accessing resource 110, or through a more general application 116 that can access multiple services, such as a web browser, or portions of an operating system. In some embodiments, resource 110 can be a plurality of resources, such as a network or enterprise system.

Resource 110 can authenticate the identity of user 102 on its own through use of an authentication mechanism and can utilize the authentication service 108 to provide an additional factor of authentication. For example, user 102 can attempt to access the resource 110 using the access device 114. In some embodiments, the access device 114 can also be the authentication device 104, such as when user 102 attempts to access the resource 110 using an app or browser on authentication device 104. The resource 110 can perform a first authentication mechanism by interacting with the access device 114. Thereafter, the resource 110 can request an additional authentication using authentication device 104.

In some embodiments, the additional authentication can include requesting a code generated by the authentication device 104. For example, the MFA application 106 might generate a pseudo-random number using a mechanism agreed upon with resource 110. The user 102 can operate the authentication device 104 to cause the MFA application 106 to generate the pseudo-random number, which the user 102 can then enter into the access device 114 to achieve the additional authentication. In some embodiments, if the authentication device 104 is equipped with a trust platform module 112, the MFA application 106 can utilize the trust platform module 112 to generate the psudeo-random number.

In some embodiments, the additional authentication can include requesting a code or authorization generated by the authentication device 104 by making the request through the authentication service 108. For example, the resource 110 can pass information identifying the user 102 to the authentication service 108 with a request for additional authentication. The authentication service 108 can send a request (typically a push request) for authentication to the authentication device 104, which is known to be a device associated with the user 102. The user can respond to the request for authentication on the authentication device 104 by interacting with the MFA application 106 to perform the required actions. When the required actions are properly performed, the MFA application 106 can send a communication informing the authentication service 108 of the successful authentication, and the authentication service 108 can inform the resource 110 of the successful authentication. In some embodiments, the authentication service 108 can send the access device 114 a unique ID and passcode associated with the resource 110 and the user 102. The unique ID and passcode communication can also include information to cause the application 116 on the access device 114 to use the transmitter 120 (e.g., a BTLE transmitter) as a broadcaster (e.g., a beacon) that broadcasts the unique ID and passcode within a broadcast range 124. The broadcast range 124 can be a limit of the transmitter 120 hardware capabilities, such as up to 300 feet. Typically, the broadcast range 124 is lower than 300 feet, which depends on the power of the transmitter 120 broadcasting the signal and can be up to about 60 feet. In this regard, the broadcast range 124 can be any range depending on the physical capabilities of the transmitter 120 and the environment surrounding the access device 114 and/or authentication device 104 as recognized by one with skill in the art.

In some embodiments, the additional authentication can include polling for the unique ID and passcode generated at the authentication service 108 or resource 110 to be received at the authentication service 108 from the authentication device 104. For example, the resource 110 can pass information identifying the user 102 to the authentication service 108 with a request for additional authentication. The authentication service 108 can send the unique ID and passcode to the access device 104, which then can broadcast the unique ID and passcode, such as over BTLE, to the authentication device 104 associated with the user 102. In this example, the MFA application 106 presents a user interface requesting that the user 102 to approve or deny the authentication request. The user can respond to the request for authentication on the authentication device 104 by interacting with the MFA application 106 to perform the required action. At the same time or close to the same time, if the authentication device 104 is within the broadcast range of the access device 114, the MFA application 106 can receive (e.g., receive the beacon information on receiver 122) the unique ID and passcode from the transmitter 120 on access device 114 When the code is received by receiver 122, the MFA application 106 can send a communication informing the authentication service 108 of the unique ID and passcode, and the authentication service 108 can pass the code to the resource 110 where the resource 110 will consider the additional authentication successful when the received unique ID and passcode match the unique ID and passcode sent to the access device 114. In some embodiments, the authentication service 108 can determine if the match is successful and relay successful match information to the resource 110. It should be noted that the authentication device 104 does not have to be paired or otherwise communicatively coupled with the access device 114 to receive the unique ID and passcode on receiver 122 from the transmitter 120. In this regard, a user 102 is not required to have to pair or otherwise communicatively couple the authentication device 104 with the access device 114 which can save the user 102 time and battery life, among other things. However, in some embodiments, the authentication device 104 can be communicatively coupled to the access device 114, but this coupling is not required to practice the methods described herein.

In some embodiments, the authentication device 104 and/or the access device 114 can also report context data to the authentication service 108. As addressed above the authentication device 104 can include the MFA application 106 that can communicate with the authentication service 108. The access device 114 can include a security agent 118 that can also communicate with the authentication service 108. The MFA application 106 and the security agent 118 can gather and send information to the authentication service 108. For example, the information can include biometric, behavioral, and contextual data from user 102. These biometrics can include, for example, fingerprints, facial detection, retinal scans, voice identification, or gait data, among other biometrics. The context data can include a time since the user last interacted with the device, changes to the network connection experienced by the device, information about the integrity of the operating system of the device, information about what operating system and what version of the operating system the device is running, among other examples. This information can be used by the authentication service 108 to determine if the device should be trusted to be used as part of the authentication process or trusted to access the resource 110. In some instances, the information can indicate that something has changed about the user 102, the authentication device 104, or the access device 114 during an authenticated session with resource 110 can take certain actions depending on a configured policy to access the resource 110.

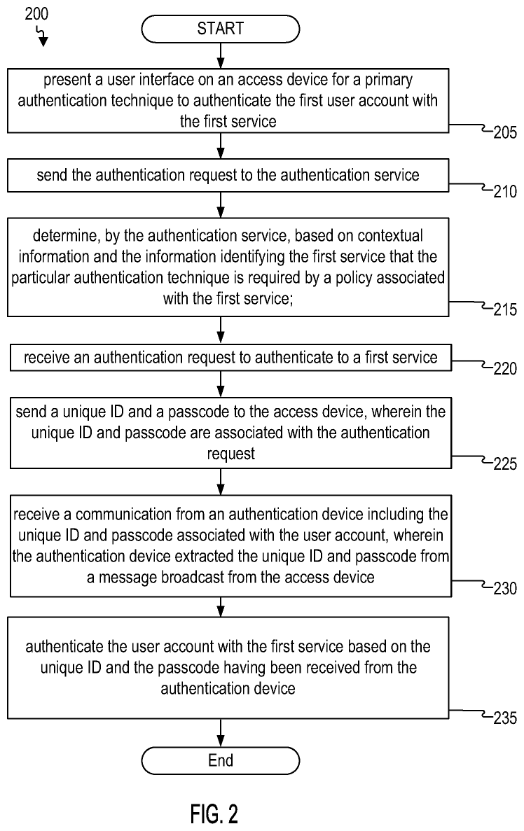

FIG. 2 illustrates an example method 200 for ensuring the proximity of an authentication device through Bluetooth Low Energy signals, which includes various aspects of the disclosure as they relate to receiving a pre-authorization, receiving a request to authenticate, sending a unique ID and passcode to an access device, receiving the unique ID and passcode from the authentication device, and allowing or denying authorization. Although the example method 200 depicts a particular sequence of operations, the sequence can be altered without departing from the scope of the present disclosure. For example, some of the operations depicted can be performed in parallel or in a different sequence that does not materially affect the function of the method 200. In other examples, different components of an example device or system that implements the method 200 can perform functions at substantially the same time or in a specific sequence.

According to some examples, the method includes presenting a user interface for a primary authentication technique to authenticate the first user account with the resource at block 205. For example, the access device 114, illustrated in FIG. 1, can present a user interface for a primary authentication technique to authenticate the first user account with the resource (i.e., resource 110), such as through an application installed on the user's 102 laptop (i.e., access device 114). As previously discussed, access device 114 can include hardware (e.g., a computer), software (e.g., a browser extension), a website (e.g., a web portal) hosted on a separate computing device, or any other application of the device capable of presenting the interface for a primary authentication technique. In some examples, the primary authentication technique is a username and password. In some examples, the primary authentication technique can be any authentication technique capable of verifying the user's 102 information. It should be noted that presenting a user interface for a primary authentication technique can have been initiated by a bad actor as part of an initial step in gaining access to a resource 110. In some examples, a legitimate user 102 can have requested the primary authentication technique while a bad actor is inconspicuously monitoring the legitimate user, such as in an adversary-in-the-middle attack. In this regard, the primary authentication technique can be presented based on a legitimate request, an illegitimate request, or simultaneous legitimate and illegitimate requests.

According to some examples, the method includes sending the authentication request to the authentication service at block 210. For example, the resource 110 can send the authentication request to the authentication service 108. In some examples, the authentication service is a multi-factor authentication service. In some examples, the authentication service is a two-factor authentication (2FA) service. In this regard, the authentication service can require one or more factors to authenticate the user in various possible examples. In some examples, the authentication request includes contextual information associated with the access device 114 of the request and information identifying the resource 110. The authentication request can include contextual information associated with the request and/or the user 102 including the IP address of the access device, a browser version, an identification of browser extensions, an operating system on the access device, a type of access device, time of day, geographical information, combinations of the same, etc., in various possible examples. In some examples, the contextual information associated with the access device 114, authentication device 104, and/or user 102 includes one or more of data identifying a network from which the access device or authentication device is connected. In some examples, the request or contextual information includes information about the user, such as a name or username, password, user ID, combinations of the same, etc., in various possible examples.

According to some examples, the method 200 includes determining, by the authentication service and/or authentication device, based on the contextual information and the information identifying the resource that the particular authentication technique is permitted by a policy associated with the resource at block 215. For example, the authentication service 108 illustrated in FIG. 1 can determine, based on the contextual information and the information identifying the resource 110, that the particular authentication technique is permitted by a policy associated with the resource 110. In some examples, the authentication service 108 can set the policy associated with the resource 110. In some examples, the policy can be set by the resource 110. In some examples, the policy can be set by an administrator or user of the resource 110. It should be noted that the policy associated with the particular authentication technique can be updated, adjusted, changed, or otherwise set for each user 102 or user account, groups of users or accounts, resource 110, particular authentication technique, authentication device 104, authentication session, combinations of the same, etc., in various possible examples.

Further, the method 200 can determine that the contextual information, such as from the access device, is only allowed to utilize a subset of available authentication techniques (e.g., two of five available authentication techniques) associated with the resource, authentication service, and/or policy. For example, the contextual information can include information that the user 102 is on a public network (e.g., accessing the internet on a laptop in a coffee shop), and the authentication provider 108 can determine (e.g., based on the policy and the contextual information) that the user 102 can only utilize a push type authentication method or biometric authentication method coupled with the proximity method disclosed herein. In this regard, the authentication provider 108 and/or authentication device 104 can consider contextual information associated with the request and/or the user 102 to indicate a higher risk associated with allowing the user to use particular authentication techniques or requiring the additional proximity method.

According to some examples, the method includes receiving an authentication request to authenticate to a resource, at block 220. For example, a bad actor using an ill gotten (e.g., obtained from malware, purchased on a black market, intercepted from a message, etc.) primary authentication technique (e.g., a genuine username and password) associated with a legitimate user account can initiate an authentication request to authenticate to a resource in hopes that the legitimate user will approve the request once it is generated from the authentication service 108, authentication device 104, and/or the resource 110 thereby allowing the bad actor access to the resource 110. In some examples, the bad actor can initiate one or more requests. In some examples, the bad actor can initiate many requests for authentication to the resource (e.g., a push spray attack) at the same time, or can initiate the requests one after another over a period of time (e.g., a push harassment attack). In some examples, a legitimate user 102 can have requested the primary authentication technique while a bad actor is inconspicuously monitoring the legitimate user, such as in an adversary-in-the-middle attack or a passcode phishing attack. In some examples, the bad actor and the user 102 can have initiated the request to authenticate to a resource at the same time or within a short period of time (e.g., within 10 minutes of each other). In this regard, the received request to authenticate to a resource can be a legitimate request or can be an illegitimate request.

According to some examples, the method includes sending a unique ID and a passcode to the access device, wherein the unique ID and passcode are associated with the authentication request at block 225. For example, when the resource 110 requests additional authentication of a user account by the authentication service 108, the authentication service 108 can send the unique ID and passcode to the access device 114. The security service 118 at the access device 114 can receive the unique ID and passcode from the authentication service 108. In some examples, the resource 110 provides the unique ID and passcode to the authentication service 108 before the authentication service 108 sends the unique ID and passcode to the access device 114. In some examples, the authentication service 108 generates the unique ID and passcode. In some examples, the authentication service 108 can encrypt the unique ID and passcode before sending it to the access device 114. In some examples, the authentication service 108 can set a policy associated with the resource 110 that determines when the proximity authentication technique is required for authentication. In some examples, the policy can be set by the resource 110. In some examples, the policy can be set by an administrator or user of the resource 110. It should be noted that the policy associated with the particular authentication technique can be updated, adjusted, changed, or otherwise set for each user 102 or user account, groups of users or accounts, resource 110, particular authentication technique, authentication device 104, authentication session, combinations of the same, etc., in various possible examples.

In some examples, a rule or policy can define that the user account can be under attack when the user account is attempting to authenticate from an IP address not previously associated with the user account. In some examples, the authentication service 108 can see the characteristics associated with some attacks as normal, below an individualized threshold, such as if the provider/service (e.g., resource 110) utilizes a VPN for access devices. The user 102 can routinely attempt to authenticate from different IP addresses within a range of addresses associated with the VPN, and this would be normal i.e., within a threshold configured by the service where the service knows the range of possible addresses. In this regard, the access policy can specify a rule for determining that the authentication request is subject the additional proximity method in various possible examples. In some examples, the access policy is defined by the resource and can be based on the contextual information. In some examples, the access policy requires all users 102 of the service to also include the proximity method for authentication.

According to some examples, the method includes receiving a communication from an authentication device 104 including the unique ID and passcode associated with the user 102 account, wherein the authentication device 104 extracted the unique ID and passcode from a message broadcast from the access device 114 at block 230. In some examples, the unique ID and passcode were transmitted (e.g., by transmitter 120) over a BTLE signal and included in a portion of the signal visible to devices not communicatively coupled or otherwise paired with the access device 114. In this regard the unique ID and passcode can be extracted by the MFA application 106 on the authentication device 104 without being paired to the access device 114. The BTLE signal ensures geographic co-location between the authentication device 104 and the access device 114. In some examples the unique ID and passcode can be extracted by the MFA application 106 while the authentication device 104 is paired with the access device 114. It should be noted that the unique ID and passcode can be encrypted. In this regard, the MFA application 106 can decrypt the unique ID and passcode before sending it to the authentication service 108.

In some examples, the method includes authenticating the user account with the first service (e.g., resource 110 in FIG. 1) based on the unique ID and the passcode having been received from the authentication device 104. For example, the MFA application 106 can extract the unique ID and passcode from the broadcast signal and include them in the data packet that is sent back to the authentication service 108. In some examples, the unique ID and passcode are sent to the authentication service 108 when the user 102 approves the request for authentication on the authentication device 104. In some examples, the MFA application 106 can authenticate the user 102 after having successfully extracted the unique ID and passcode from the broadcast sent by the access device 114. In some examples, the MFA application 106 can send the unique ID and passcode to the authentication service 108 without any interaction from the user 102. In this regard, the authentication service can receive the unique ID and passcode with or without user 102 interaction. Although not shown, method 200 can repeat any step, combine steps, skip steps, iterate steps, combinations of the same, etc., in various possible examples.

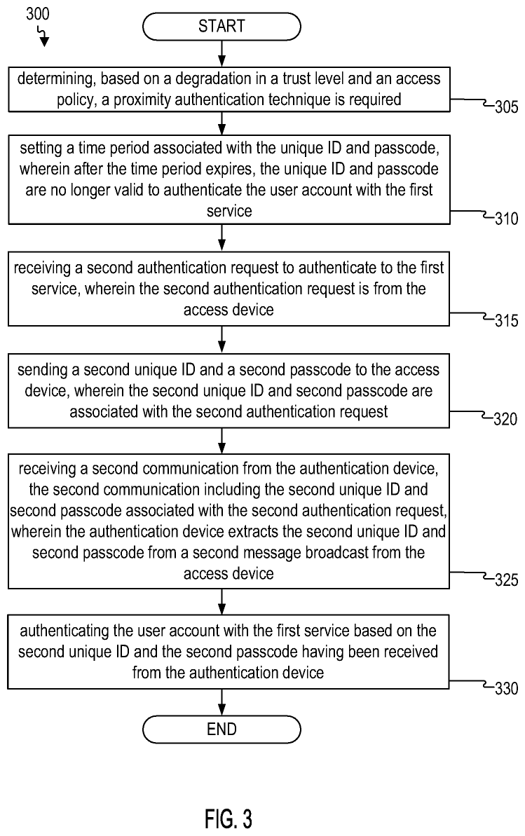

FIG. 3 shows an example method 300 of the proximity authentication technique disclosed herein including setting a time period which can be associated with the unique ID and passcode. According to some examples, the method 300 includes determining, based on a degradation in a trust level and an access policy, a proximity authentication technique is required at step 305. In some examples, a proximity authentication technique can be used as an alternative authentication technique if a specific attack detected, policy, rule, combinations of the same, etc., requires the proximity authentication technique. In some examples, the access policy associated with the resource 110 can specify or be configured to specify when the proximity authentication technique can be used as an alternative/additional authentication technique.

In some examples, the method 300 includes setting a time period associated with the unique ID and passcode, wherein after the time period expires, the unique ID and passcode are no longer valid to authenticate (e.g., via the authentication service 108 shown in FIG. 1) the user account with the first service (e.g., with resource 110 shown in FIG. 1) at block 305. In this regard, the period can be set to mitigate the risk of an ongoing attack thereby reducing the chances that a bad actor gains access to the resource 110. In some examples, the period can be set by the authentication service or can be set by the policy associated with the resource. In some examples, the policy can be set by the resource 110. In some examples, the policy can be set by an administrator or user of the resource 110. It should be noted that the period associated with the proximity authentication technique can be updated, adjusted, changed, or otherwise set for each user 102 or user account, groups of users or accounts, resource 110, particular authentication technique, authentication device 104, authentication session, combinations of the same, etc., in various possible examples.

According to some examples, the method 300 includes receiving a second authentication request to authenticate to the first service, wherein the second authentication request is from the access device at block 315. For example, if the time period associated with the first unique ID and passcode has expired and the user tries to authenticate with the first service, the authentication service 108 can deny access to the user 102 and/or require the user 102 to re-authenticate. In this regard, the authentication service 108 can generate a new unique ID and passcode or receive a new unique ID and passcode from resource 110.

According to some examples, the method 300 includes sending a second unique ID and a second passcode to the access device, wherein the second unique ID and second passcode are associated with the second authentication request at block 320. For example, the authentication service 108 can send to the access device 114 a second unique ID and passcode differing from the expired first unique ID and passcode. This second unique ID and passcode can be used to authenticate the user account after the first unique ID and passcode has expired. It should be noted that the second unique ID and passcode can be sent to the access device 114 without a request for authentication by the user and can be initiated by the authentication service 108, the resource 110, or a policy associated with the user account and/or resource.

According to some examples, the method 300 includes receiving a second communication from the authentication device, the second communication including the second unique ID and second passcode associated with the second authentication request, wherein the authentication device extracts the second unique ID and second passcode from a second message broadcast from the access device at block 325. For example, the second message can be broadcast via a BTLE signal, which ensures geographic co-location between the authentication device and the access device. The authentication service can receive a second request to authenticate the user account with the first service after the first authentication attempt failed and/or timed out. In this regard, the authentication service 108 can send or continue to send a unique ID and passcode to the access device 114 until a successful authentication occurs or until a threshold set by a policy is reached.

According to some examples, the method 300 includes authenticating the user account with the first service based on the second unique ID and the second passcode having been received from the authentication device at block 330. For example, after receiving the second unique ID and passcode from the authentication device 104, the authentication service 108 can determine that the access device 114 and the authentication device 104 are co-located (i.e., within a know proximity to each other) thereby increasing a likelihood that the user requesting access to the resource 110 is authentic and authorized to access resource 110. Although not shown, method 300 can repeat any step, combine steps, skip steps, iterate steps, combinations of the same, etc., in various possible examples.

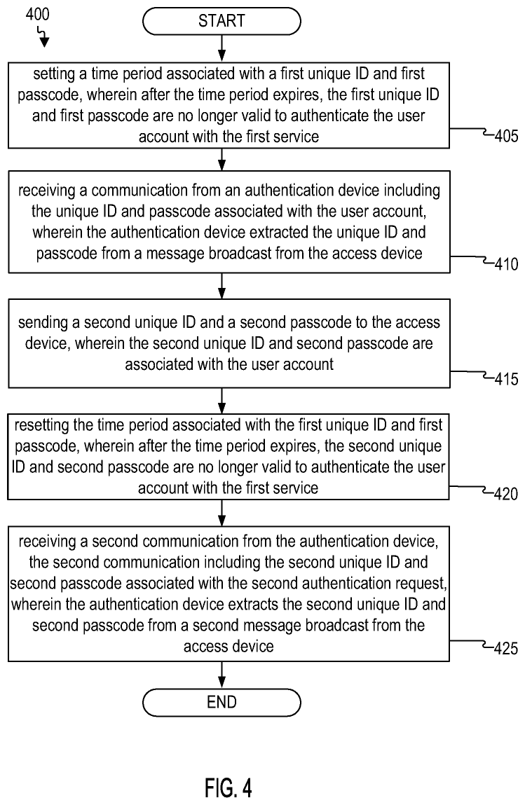

FIG. 4 shows an example method 400 of one aspect of the present disclosure. According to some examples, the method 400 includes setting a time period associated with a first unique ID and first passcode, wherein after the time period expires, the first unique ID and first passcode are no longer valid to authenticate the user account with the first service at step 415. For example, a rule or policy can require the continual or semi-continual authentication of the user based on the proximity authentication technique disclosed herein. In this regard, the authentication service 108 can repeatedly send the access device 114 a new unique ID and passcode at set intervals based on a set time period, where the authentication service 108 then polls the authentication device for each new unique ID and passcode over the period of time thereby ensuring that the access device 114 and the authentication device are continuously co-located over that period of time.

According to some examples, the method 400 includes receiving a communication from an authentication device including the unique ID and passcode associated with the user account, wherein the authentication device extracted the unique ID and passcode from a message broadcast from the access device at block 410.

According to some examples, the method 400 includes sending a second unique ID and a second passcode to the access device, wherein the second unique ID and second passcode are associated with the user account at block 415. For example, the authentication service sends the new second unique ID and second passcode to the access device 114 causing the access device 114 to transmit, via transmitter 120, the second unique ID and passcode. In some embodiments, transmitter 120 can transmit the second unique ID and passcode by a BTLE signal, which ensures geographic co-location between the authentication device 104 and the access device 114. In this regard, if the authentication device 104 is still within the broadcast range 124 of the access device 114, the authentication device 104 can extract the second unique ID and second passcode from the transmitted signal.

According to some examples, the method 400 includes resetting the time period associated with the first unique ID and first passcode, wherein after the time period expires, the second unique ID and second passcode are no longer valid to authenticate the user account with the first service at block 420. For example, the authentication service 108 can reset the time period for which it will continue to allow (e.g., by security agent 118) the access device to access the resource 110. In this regard, if the authentication service does not receive the second unique ID and second passcode from the authentication device 104, the authentication service can cause security agent 118 to block access to resource 110 or can disconnect the access device 114 from the resource 110.

According to some examples, the method 400 includes receiving a second communication from the authentication device, the second communication including the second unique ID and second passcode associated with the second authentication request, wherein the authentication device extracts the second unique ID and second passcode from a second message broadcast from the access device at block 425. The second message can be broadcast by a BTLE signal, which ensures geographic co-location between the authentication device 104 and the access device 114. Once the authentication service 108 receives the second unique ID and second passcode, the authentication device can continue to allow the access device 114 to access resource 110. In some examples, the authentication service then repeats the method from block 405 through block 425 based on a policy or rule associated with resource 110. In this regard, method 400 can repeat any step, combine steps, skip steps, iterate steps, combinations of the same, etc., in various possible examples.

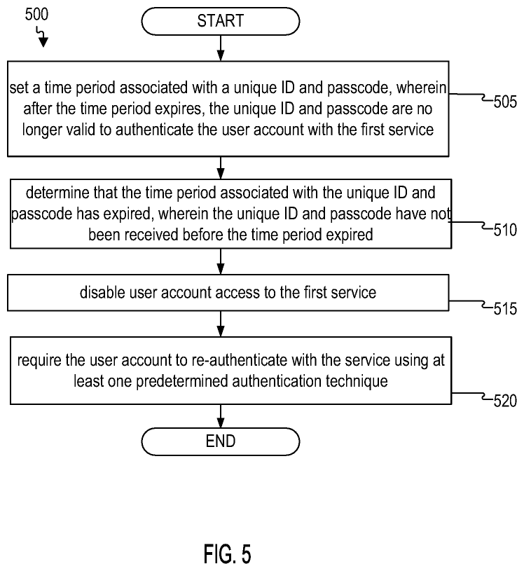

FIG. 5 shows an example method 500 of one aspect of the present disclosure. According to some examples, the method 500 includes set a time period associated with a unique ID and passcode, wherein after the time period expires, the unique ID and passcode are no longer valid to authenticate the user account with the first service at block 505.

According to some examples, the method 500 includes determining that the time period associated with the unique ID and passcode has expired, wherein the unique ID and passcode have not been received before the time period expired at block 510. In some examples, the unique ID and passcode can be successive unique ID and passcodes (i.e., not the first unique ID and passcode) where the current (e.g., fifth unique ID and passcode) time period associated with the unique ID and passcode has expired after the access device has been accessing resource 110 over the period of time without the authentication service 108 receiving the current unique ID and passcode.

According to some examples, the method 500 includes disabling the user account's access to the first service (e.g., resource 110 shown in FIG. 1) at block 515. In some examples, disabling the user account's access to the first service can include pausing the interactions with the resource 110 at the access device 114 via security agent 118. In some examples, disabling the user account's access to the first service can include dropping a connection established between the access device 114 and the resource 110. In some examples, disabling the user's account access to the first service can include redirecting application 116 on the access device 114 to a proxy or causing a pop-up type message to appear in application 116 or otherwise on the access device 114 including instructions on how to re-authenticate and/or continue accessing resource 110.

According to some examples, the method 500 includes requiring the user account to re-authenticate with the service using at least one predetermined authentication technique at block 520. In this regard, the user 102 account cannot use resource 110 until the user re-authenticates with authentication service 108. Restricting the techniques can help mitigate the risks associated with an ongoing attack while still allowing the user 102 account to be authenticated thereby facilitating the user's 102 ability to continue working. Although not shown, method 500 can repeat any step, combine steps, skip steps, iterate steps, combinations of the same, etc., in various possible examples.

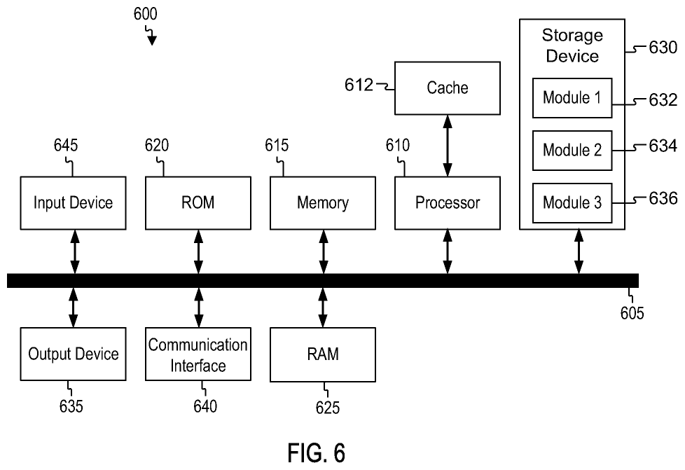

FIG. 6 shows an example of computing system 600, which can be for example any computing device making up the access device 114, authentication device 104, authentication service 108, resource 110, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments computing system 600 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read only memory (ROM) 620 and random-access memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 can essentially be a completely self-contained computing system, containing multiple cores or processors, a bus, memory controller, cache, etc. A multi-core processor can be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement and therefore the basic features here can easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances the present technology can be presented as including individual functional blocks including functional blocks comprising devices, device components, steps or routines in a method embodied in software, or combinations of hardware and software.

Any of the steps, operations, functions, or processes described herein can be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for using multi-factor authentication to authenticate a user account, the method comprising:
receiving an authentication request to authenticate a user account to a first service, wherein the authentication request is from an access device;
sending a passcode to the access device, wherein the passcode is associated with the authentication request; and
receiving a communication from an authentication device including the passcode associated with the user account, wherein the authentication device extracted the passcode from a message broadcast over Bluetooth Low Energy from the access device to determine co-location of the authentication device and the access device.

2. The method of claim 1, further comprising:
authenticating the user account with the first service based on a unique ID and the passcode having been received from the authentication device; and
sending a successful authentication message to the first service, wherein the successful authentication message causes the first service to establish a session between the access device and a resource.

3. The method of claim 1, wherein sending a unique ID and passcode to the access device and receiving the unique ID and the passcode from the authentication device requires no interaction from a user.

4. The method of claim 1, further comprising:
setting a time period associated with a unique ID and passcode, wherein after the time period expires, the unique ID and passcode are no longer valid to authenticate the user account with the first service.

5. The method of claim 1, wherein when the authentication device extracts a unique ID and the passcode from the broadcasted message, the authentication device is not required to be paired with the access device.

6. The method of claim 1, wherein the communication further comprises contextual information associated with at least one of the user account, the access device, and the authentication device.

7. The method of claim 1, wherein the first service is associated with an access policy configured at an authentication service, the access policy specifies a rule for determining when a unique ID and the passcode are sent to the access device.

8. A computing apparatus comprising:
a processor; and
a memory storing instructions that, when executed by the processor, configure the apparatus to:
receive an authentication request to authenticate a user account to a first service, wherein the authentication request is from an access device;
send a passcode to the access device, wherein the passcode is associated with the authentication request; and
receiving a communication from an authentication device including the passcode associated with the user account, wherein the authentication device extracted the passcode from a message broadcast over Bluetooth Low Energy from the access device to determine co-location of the authentication device and the access device.

9. The computing apparatus of claim 8, wherein the instructions further configure the apparatus to:
authenticate the user account with the first service based on a unique ID and the passcode having been received from the authentication device; and
send a successful authentication message to the first service, wherein the successful authentication message causes the first service to establish a session between the access device and a resource.

10. The computing apparatus of claim 8, wherein sending a unique ID and the passcode to the access device and receive the unique ID and passcode from the authentication device requires no interaction from a user.

11. The computing apparatus of claim 8, wherein the instructions further configure the apparatus to:
set a time period associated with a unique ID and the passcode, wherein after the time period expires, the unique ID and passcode are no longer valid to authenticate the user account with the first service.

12. The computing apparatus of claim 8, wherein when the authentication device extracts a unique ID and the passcode from the broadcasted message, and wherein the authentication device is not required to be paired with the access device.

13. The computing apparatus of claim 8, wherein the communication further comprises contextual information associated with at least one of the user account, the access device, and the authentication device.

14. The computing apparatus of claim 8, wherein the first service is associated with an access policy configured at an authentication service, the access policy specifies a rule for determining when the unique ID and passcode are sent to the access device.

15. A non-transitory computer-readable storage medium, the computer-readable storage medium including instructions that when executed by a computer, cause the computer to:
receive an authentication request to authenticate a user account to a first service, wherein the authentication request is from an access device;
send a passcode to the access device, wherein the passcode is associated with the authentication request; and
receiving a communication from an authentication device including the passcode associated with the user account, wherein the authentication device extracted the passcode from a message broadcast over Bluetooth Low Energy from the access device to determine co-location of the authentication device and the access device.

16. The computer-readable storage medium of claim 15, wherein the instructions further configure the computer to:
authenticate the user account with the first service based on a unique ID and the passcode having been received from the authentication device; and
send a successful authentication message to the first service, wherein the successful authentication message causes the first service to establish a session between the access device and a resource.

17. The computer-readable storage medium of claim 15, wherein sending a unique ID and the passcode to the access device and receive the unique ID and passcode from the authentication device requires no interaction from a user.

18. The computer-readable storage medium of claim 15, wherein the instructions further configure the computer to:
set a time period associated with a unique ID and the passcode, wherein after the time period expires, the unique ID and passcode are no longer valid to authenticate the user account with the first service.

19. The computer-readable storage medium of claim 15, wherein when the authentication device extracts a unique ID and the passcode from the broadcasted message, and wherein the authentication device is not required to be paired with the access device.

20. The computer-readable storage medium of claim 15, wherein the communication further comprises contextual information associated with at least one of the user account, the access device, and the authentication device.
